(19) United States
(12) Patent Application Publication
(10) Pub. No.: US 2007/0124614 A1
(43) Pub. Date: May 31, 2007

(54) Universal serial bus apparatus and method for managing power in universal serial bus apparatus

(76) Inventors: Hyun Jeong Lee, Daejeon (KR); Jae Doo Huh, Daejeon (KR); Kwang Roh Park, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/604,585

(22) Filed: Nov. 27, 2006

(30) Foreign Application Priority Data
Nov. 25, 2005 (KR) 10-2005-0113569

(51) Int. Cl. G06F 1/00

(52) U.S. Cl. 713/300

(57) ABSTRACT

In order to manage power in a wireless type USB apparatus including a solar battery and a power controller and to perform data transmission and reception to and from a wireless type USB host, the solar battery supplies power, and whether the wireless type USB host and apparatus are powered on is checked, the connection is performed or released according to the checking, the state of the wireless type USB apparatus is switched to a dormant state when the connection is released from the wireless type USB host, and the power consumption is reduced by the power controller. Thus, power is easily supplied and the connection and the power are effectively managed.

### RELATED APPLICATION

The present application is based on, and claims priority from, Korean Application Number 2005-0113569, filed Nov. 25, 2005, the disclosure of which is incorporated by reference herein in its entirety.

### BACKGROUND OF THE INVENTION

1. Field of the Invention

The present invention relates to a universal serial bus (USB) apparatus, and more particularly, to a universal serial bus apparatus to which a solar battery and a power controller are attached and an electric power managing method of reducing power consumption of the universal serial bus apparatus.

2. Description of the Related Art

In general, a universal serial bus (hereinafter, referred to as a ‘USB’) is a device to conveniently connect a peripheral device to a computer manufactured by any manufacturer, and is developed for the purpose of a standard of an interface to the peripheral device such as a mouse, a printer, a modem, a speaker, or the like to the computer. If using the USB, since complicated adapters can be eliminated, a USB port is installed in a majority of standard devices of personal computers at the moment. Recently, the USB is mostly used to transfer data from a mobile phone, a digital camera, or the like to the personal computer.

The USB is a technology born by a technology developing conference started in 1993 by four companies, Intel, Compaq, NEC, and MicroSoft, for the convenient use and a wide extension, and a joint research of seven companies including IBM, DEC, and Northern Telecom participated therein later. The USB has rapidly developed after the USB 1.0 standard proposed in 1996 to the USB 2.0 standard proposed in 2000. The standard of a wireless type USB 1.0 in which a convenience of a wireless data transfer is added to data transfer rate and security of a wire data transfer was completed recently.

USB Implementers Forum (USB-IF) supports the standard and all other matters. A basic transfer technology of the wireless type USB is based on an Ultra Wide Band (UWB) wireless platform, and its standardization is carried out by WiMedia Alliance.

Recently, the USB has a trend of making a foothold of the success of the wire USB and being combined to a future wireless technology, and is applied, like the application of the wireless technology, to a personal computer, a peripheral device of the personal computer, a home appliance, and a mobile communication apparatus.

The wireless type USB is a technology in which convenience is added to the performance and security function of the wire USB, and a relationship between a wireless type USB host and devices is a star topology in which the devices are directly connected to the wireless type USB host in point-to-point. This connection between a single wireless type USB host and several wireless type USB devices is named by a cluster, and there is no hub unlike the wire USB. The wireless type USB host can logically connect 127 devices thereto, starts data transfer to and from the devices in the cluster, performs a scheduling, and allocates a time slot and broadband to the connected devices.

A method of providing the USB functions in wireless line and a method of controlling an electric power of the wireless type USB apparatus according to a power control of the USB host are being researched.

A conventional wireless type USB apparatus is supplied with the electric power from a self-power supply and a bus power. According to this power supplying method, the USB apparatus is directly connected to the power supply to be supplied with the electric power.

However, if there is no apparatus to supply electric power around the USB apparatus, since the wireless type USB apparatus is not supplied with the electric power, the communication is impossible. Thus, as the wire USB is developed to the wireless type USB, a method of more conveniently supplying power is required, and a method of reducing power consumption is required too. However, hereinbefore, the research is carried out without treatment and consideration of the methods mentioned above.

### SUMMARY OF THE INVENTION

Therefore, the present invention has been made in view of the above problems, and it is an aspect of the present invention to provide a wireless type universal serial bus (USB) apparatus to which electric power is supplied from an attached solar battery, a conventional self-power supply, and a BUS power and in which power consumption can be minimized by being switched to a dormant state and by a power controller, and a power managing method of a wireless type USB.

It is another aspect of the present invention to provide a wireless type universal serial bus with a power controller to be utilized in the connection to and the release from a host and a power managing method of the wireless type universal serial bus.

In accordance with an aspect of the present invention, the above and other aspects can be accomplished by the provision of a power managing method of a wireless type universal serial bus apparatus associated with a wireless type universal serial bus host and attached with a solar battery to receive solar energy, the method including: supplying an electric power from the solar battery; recharging the wireless type universal serial bus apparatus with the supplied electric power; performing a power control to reduce a consumption of the supplied electric power by periodically checking whether the wireless type universal serial bus host and the wireless type universal serial bus apparatus are powered on or off; and a switching of a state of the wireless type universal serial bus apparatus to a dormant state when all of the wireless type universal serial bus host near the apparatus are powered off during the power control.

Another aspect of the present invention can be accomplished by the provision of a wireless type universal serial bus apparatus associated with a wireless type universal serial bus host to carry out wireless universal serial data transmission and reception and a multimedia streaming service, the apparatus including: a main body including a solar battery attached to an outer side thereof to supply an electric power and a rechargeable device to supply the electric power when the electric power is off; a power controller to control a connection to and a release from the wireless type universal serial bus host, and a switching of a state of the wireless type universal serial bus apparatus to a dormant state to reduce a power consumption when the wireless type universal serial bus host is powered off; and a universal serial bus plug to be directly connected to the wireless type universal serial bus host.

Still another aspect of the present invention can be accomplished by the provision of a wireless type universal serial bus apparatus having a solar battery and a power controller and performing data transmission/reception to and from a wireless type universal serial bus host and a multimedia streaming service, the apparatus including: a power managing process to manage an electric power supplied from a solar battery, a self-power, and a bus power; a wireless processing process to process a communication with the wireless type universal serial bus host using wireless media; a connection managing process to manage the connection to and the release from the wireless type universal serial bus host, and to switch a state of the wireless type universal serial bus apparatus to a dormant state when the wireless type universal serial bus host is powered off; and a data transfer process to transfer and receive data to and from the wireless type universal serial bus host and to carry out the multimedia streaming service.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a wireless type universal serial bus platform according to an embodiment of the present invention;

FIG. 2 is a schematic view illustrating a wireless type USB apparatus to which a solar battery and a power controller are attached, according to an embodiment of the present invention;

FIG. 3 is a functional block diagram illustrating a wireless type universal serial bus (USB) according to an embodiment of the present invention; and

FIG. 4 is a flowchart illustrating a process of managing electric power in the wireless type USB apparatus according to an embodiment of the present invention.

### DETAILED DESCRIPTION OF THE PREFERRED EMBODIMENTS

Hereinafter, the structure and operation of the present invention will now be described with reference to the attached drawings. It is noted that although similar components are depicted in different drawings, same reference numerals are assigned to the similar components if possible. In the following description of the present invention, if it is determined that the detailed description of already known components or functions related to the present invention may confuse the subject matter of the present invention, the detailed description will be omitted.

In the present invention, a solar battery and a power controller are attached to a wireless type universal serial bus (hereinafter, referred to as a ‘USB’) apparatus, and the wireless type USB can be applied to a personal computer (hereinafter, referred to as a ‘PC’), a peripheral device of the PC, a home appliance, a mobile communication apparatus, and the like.

Hereinafter, a wireless type USB apparatus in which a solar battery and a power controller are attached thereto to supply an electric power and power consumption is minimized and a power managing method of the wireless USB apparatus will be described in detail with reference to the accompanying drawings.

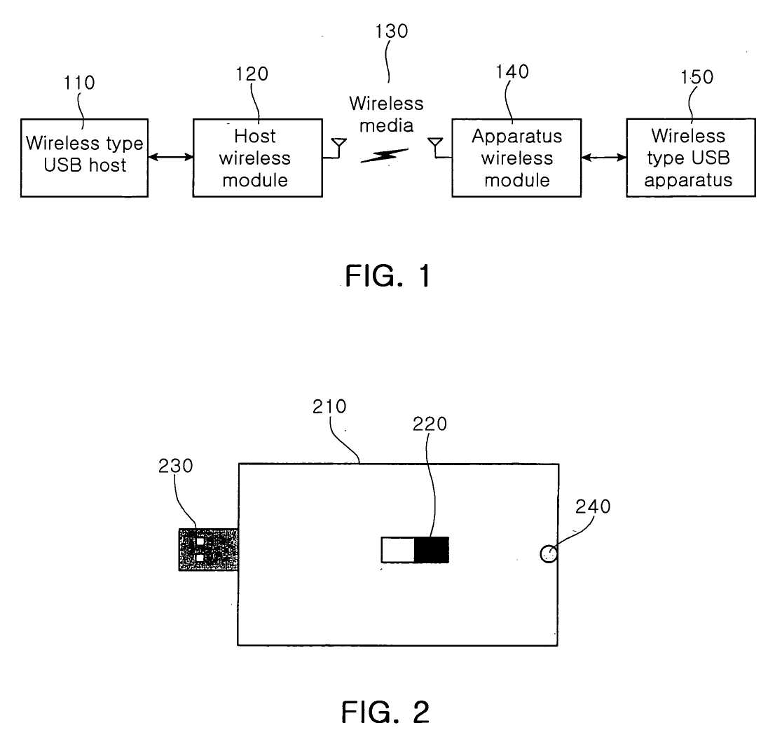

FIG. 1 is a block diagram illustrating a wireless type universal serial bus platform according to an embodiment of the present invention.

Referring to FIG. 1, a wireless USB platform includes a wireless type USB host 110, a host wireless module 120, an apparatus wireless module 140, and a wireless type USB apparatus 150. The host wireless module 120 and the apparatus wireless module 140 are connected to each other via a wireless medium 130.

The wireless type USB host 110 may be a PC, a laptop computer, a home server, or the like and interfaces with the host wireless module 120 for the communication with the wireless type USB apparatus through the wireless medium. In this case, according to the kind of the wireless type USB host, there are several interfaces. Here, if the wireless type USB host 110 is the PC or the home server, the interface can be implemented by a peripheral component interconnect (PCI), a mini PCI, and a wire USB 2.0. When the wireless type USB host 110 is the laptop computer, the wireless USB host 110 can be connected to the host wireless module 120 via a card bus, a personal computer memory card international association (PCMCIA), and the wire USB 2.0.

As the wireless medium 130 between the host wireless module 120 and the apparatus wireless module 140, various wireless type interfaces such as an ultra wide band (hereinafter, referred to as ‘UWB’), a ZigBee, a wireless LAN, and an IrDA (Infrared Data Association) can be used.

The wireless type USB apparatus 150 may be a digital camera, a digital camcorder, a portable multimedia player (PMP), a portable hard disk, a high definition television (HDTV), and the like, and communicates with the wireless type USB host 110 through the apparatus wireless module 140 via a wireless line. There is an interface such as a secure digital input output (SDIO), a compact flash, and the like, when the interface between the wireless type USB apparatus 150 and the apparatus wireless module 140 is a card type interface, and there is a wire USB 2.0 as a dongle type interface.

The configuration and function of the wireless type USB apparatus in the wireless type USB platform will be described in detail with reference to the accompanying drawings as follows.

FIG. 2 is a schematic view illustrating a wireless type USB apparatus to which a solar battery and a power controller are attached, according to an embodiment of the present invention.

As illustrated in FIG. 2, the wireless type USB apparatus includes a main body 210, a power controller 220, a USB plug 230, and a self-power port 240.

The main body 210 has solar batteries attached to entire sides thereof to be sufficiently supplied with an electric power and a rechargeable device to be recharged when power is off. Here, the rechargeable device has an overload preventing function to stop the recharging when the recharging is finished.

The power controller 220 controls the interconnection between the host and the apparatus and the release therebetween to reduce power consumption. In other words, when the wireless type USB apparatus is within a zone where the wireless type USB apparatus can communicate via a wireless line that is powered on, the connection to the wireless type USB host is tried. After that, when the wireless type USB apparatus is out of the wireless communication zone of the wireless type USB apparatus or is powered off, the connection to the wireless type USB host is released. On the other hand, when the wireless type USB apparatus is powered on and connected to the wireless USB host and the wireless type USB host is powered off, the connection is released and the wireless type USB apparatus goes into a dormant state to reduce the power consumption. At that time, when the wireless type USB host is powered on again, the wireless type USB host tries to be connected to the wireless type USB apparatus in the dormant state. From the above-mentioned operation, a difference between a state of the wireless type USB apparatus being powered off and in the dormant state can be noticed. In other words, when the wireless type USB apparatus is powered off, the connection is not tried even when the wireless type USB host is powered on.

The USB plug 230 is used to connect the wireless type USB apparatus directly to the wireless type USB host or to a USB hub and the apparatus wireless module, like the conventional USB apparatus. The wireless type USB apparatus can be supplied with a bus power using the USB plug 230.

The self-power port 240 is a port to enable supply of electric power from the self-power like the conventional USB apparatus, and is used to supply the electric power from the solar battery and to supply the electric power when the bus power cannot be supplied.

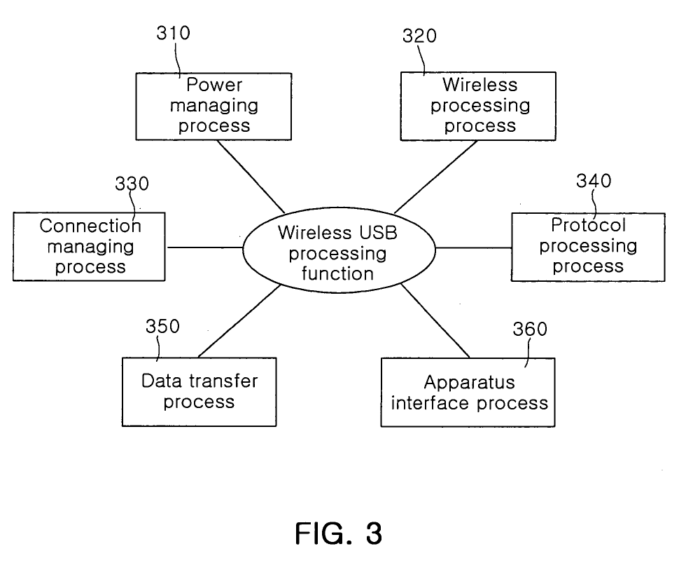

FIG. 3 is a functional block diagram illustrating a wireless type universal serial bus (USB) according to an embodiment of the present invention. Here, processes indicate logical units of functions of software, and the communication between the processes is carried out by an inter-process communication (IPC) and a function call. Moreover, it is noticed that a function of processing the conventional wire USB 2.0 installed in the wireless type USB apparatus is not described in the embodiments of the present invention.

As illustrated in FIG. 3, the functional configuration of the wireless type USB apparatus includes a power managing process 310, a wireless processing process 320, a connection managing process 330, a protocol processing process 340, a data transfer process 350, and an apparatus interface process 360.

The wireless type USB processing function is carried out to be supplied with the electric power from the power managing process 310 and carries out a wireless communication between the host wireless module 120 and the apparatus wireless module 140 using the wireless processing process 320.

The power managing process 310 manages the power supplied from the solar battery, the self-power, and the bus power and the rechargeable device, carries out the recharging through the overload preventing function even when the power is off, and stops the recharging when the recharging is finished.

The wireless processing process 320 allows the wireless type USB apparatus to communicate with the wireless type USB host 110 using one of various wireless media such as UWB, ZigBee, a wireless LAN, an infrared ray, and includes a media access control layer, a physical layer, and a software layer.

The connection managing process 330 carries out the connection managing function such as the connection, the connection maintenance, and a connection release between the wireless type USB host 110 and the apparatus. The connection between the wireless type USB host 110 and the apparatus is carried out when a wireless type USB apparatus within the wireless communication zone of the wireless type USB host is powered on and when a new wireless type USB apparatus goes into the wireless communication zone. After the connection, the wireless type USB host checks whether the apparatus is connected thereto periodically to maintain the connection.

The connection managing process 330 releases the connection between the wireless USB host and the apparatus when the wireless type USB host or the apparatus is powered off or the wireless type USB host releases the connection. The connection managing process 330 tries the connection between the wireless type USB host 110 and the apparatus when the wireless type USB host 110 is powered on and it is detected that the wireless type USB apparatus 150 is within the wireless communication zone of the wireless type USB host 110, and releases the connection when the wireless type USB apparatus 150 is powered off or is out of the wireless communication zone of the wireless type USB host 110.

Moreover, in a state of the connection, when the wireless type USB host 110 is powered off, the connection managing process 330 releases the connection. Due to this, the wireless type USB apparatus 150 goes into a dormant state to minimize the power consumption. In this case, when the wireless type USB host 110 is powered on again, the connection between the wireless type USB host 110 and the wireless type USB apparatus 150 is tried. This is a difference between the dormant state and a power-off state of the wireless type USB apparatus 150.

The protocol processing process 340 carries out a packet encoding/decoding function for a USB packet transfer and provides a security function at the same level as that of the wireless communication by supplementing the weakness of security function of the wireless media.

The data transfer process 350 carries out the data transmission and reception and the multimedia streaming service between the wireless type USB host and the apparatus. There are four kinds of data transfer, namely an isochronous transfer for the transfer of data requiring the real time transfer like the streaming service, a bulk transfer for the transfer of mass data, an interrupt transfer for the periodic transfer of data, and a control transfer for the transfer of control data between the host and the apparatus.

The apparatus interface process 360 is a function of interfacing an apparatus in which a wireless type USB is installed with various kinds of USB, and carries out the interfacing through the SDIO and the compact flash when apparatus in which a wireless type USB is installed is a board type, and through the wire USB 2.0 when apparatus in which a wireless type USB is installed is a dongle type. The apparatus interface process 360 carries out the interfacing between a module (a board type or a dongle type) in which the wireless type USB is installed with various apparatuses such as a digital camera, a digital camcorder, a PMP, a portable hard disk, an HDTV, and the like.

In the wireless type USB apparatus, a wireless type USB power managing method of supplying electric from the self-power, the bus power, and the solar battery, adding the power controller to minimize the power consumption, and adding a dormant state entering function of the wireless type USB apparatus to minimize the power consumption will be described in detail with reference to the accompanying drawings.

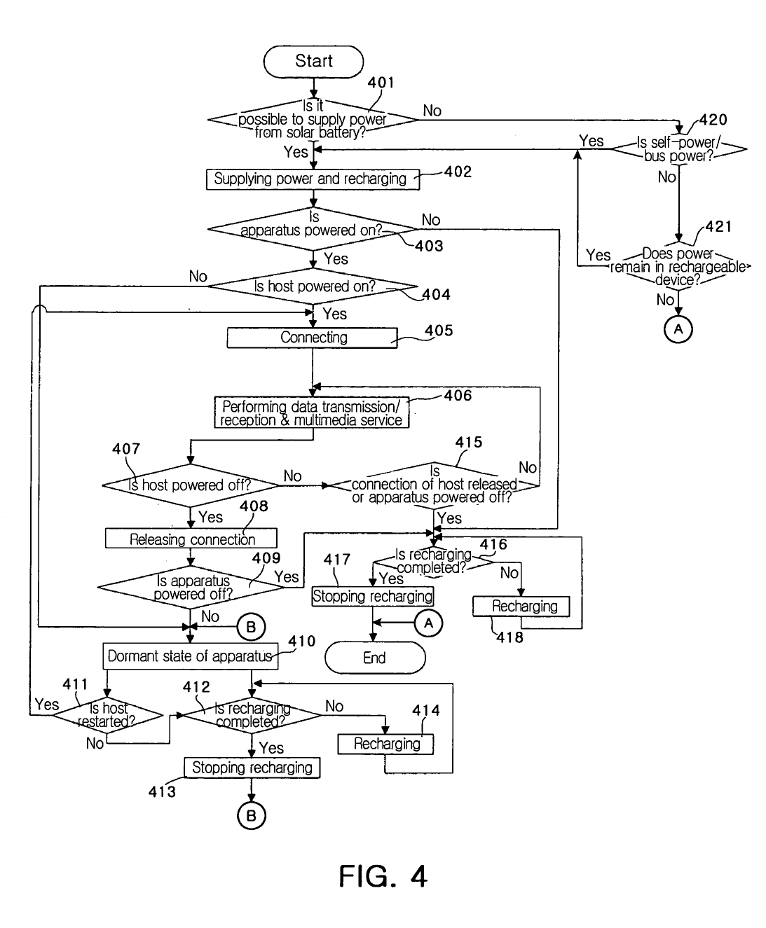

FIG. 4 is a flowchart illustrating a process of managing electric power in the wireless type USB apparatus according to an embodiment of the present invention.

Referring to FIG. 4, in the process 401, the wireless type USB apparatus checks whether the power can be supplied from the solar battery. As a result of the checking, when the solar battery cannot supply the electric power, the wireless type USB apparatus carries out the process 420 to check whether the self-power or the bus power can supply the electric power and carries out the process 402 when the electric power can be supplied. On the other hand, if the electric power cannot be supplied, in the process 421, the wireless type USB apparatus checks whether the electric power remains in the rechargeable device, carries out the process 402 if the electric power remains, and stops operation if no electric power remains.

As a result of the checking in the process 401, if the electric power can be supplied from the solar battery and/or the self-power, the wireless type USB apparatus, in the process 402, starts recharging with the electric power supplied from the solar battery. At that time, when the above process is carried out from the processes 420 and 421, the recharging is started by the electric power supplied from the self-power, the bus power, or the rechargeable device.

Then, in the process 403, the wireless type USB apparatus checks whether the apparatus is powered on through the connection managing process 330 and carries out the process 416 if the apparatus is powered off.

On the other hand, if the apparatus is power on, in the process 404, the wireless type USB apparatus checks whether the wireless type USB host is powered on. If the host is powered off, the process 410 is carried out, and the next process 405 is carried out when the host is powered on.

In the process 405, the wireless USB apparatus tries to be connected to the wireless type USB host 110, and carries out the data transmission and reception and the multimedia streaming service in the process 406 when the connection is completed.

After that, in the process 407, the wireless type USB apparatus checks whether the wireless type USB host is powered off, and checks whether the apparatus is powered off in the process 415 if the host is powered on. Here, even in a case of the release from the wireless type USB host 110, the same operation is carried out. As a result of the checking, if the apparatus is powered on, the process 406 is carried out, and the process 416 is carried out if not.

If the host is powered off as a result of the checking in the process 407, the wireless type USB apparatus, in the process 408, releases the connection from the wireless type USB host 110.

Next, in the process 409, the wireless type USB apparatus checks whether the apparatus is powered off, and checks whether the recharging is completed in the process 416 if the apparatus is powered off. If the recharging is completed, in the process 417, the recharging is stopped to finish the operation, and continues the recharging in the process 418 if the recharging is not completed to carry the process 416.

As a result of the checking in the process 409, if the apparatus is not powered off, the wireless type USB apparatus, in the process 410, switches the current state thereof to a dormant state and checks whether the wireless type USB host 110 is restarted in the process 411. If restarted, the process 405 is carried out, and if not the wireless type USB apparatus, in the process 412, checks whether the recharging is completed. If the recharging is completed, in the process 413, the recharging is stopped and the process 410 is carried out. If not, in the process 414, the recharging is continued and the process 412 is carried out.

As described above, according to the present invention, a solar battery is used to supply electric power easily. The electric power is supplied by the conventional way and the solar battery, so that the electric power can be supplied even when the solar battery cannot be used. The power consumption can be reduced by installing a power controller in the wireless type USB apparatus and by going into a dormant state. The connection and the power management can be more effectively performed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Modifications and equivalents will be apparent to those skilled in this art and are encompassed within the spirit and scope of the appended claims.

What is claimed is:

1. A power managing method of a wireless type universal serial bus apparatus associated with a wireless type universal serial bus host and attached with a solar battery to receive solar energy, the method comprising:
supplying an electric power from the solar battery;
recharging the wireless type universal serial bus apparatus with the supplied electric power;
performing a power control to reduce a consumption of the supplied electric power by periodically checking whether the wireless type universal serial bus host and the wireless type universal serial bus apparatus are powered on or off; and
switching a state of the wireless type universal serial bus apparatus to a dormant state when all of the wireless type universal serial bus host near the apparatus are powered off during the power control.

2. The power managing method of a wireless type universal serial bus apparatus according to claim 1, further comprising supplying the electric power from a self-power and a bus power when the electric power is not supplied from the solar battery.

3. The power managing method of a wireless type universal serial bus apparatus according to claim 1, further comprising supplying the electric power from a rechargeable device installed in the wireless type universal serial bus apparatus when the wireless type universal serial bus apparatus is powered off.

4. The power managing method of a wireless type universal serial bus apparatus according to claim 1, wherein the performing the power control comprises:
connecting the wireless type universal serial bus apparatus to the wireless type universal serial bus host when the wireless type universal serial bus host is powered on and the wireless type universal serial bus apparatus within a wireless communication zone is powered on; and
performing a wireless communication between the wireless type universal serial bus apparatus and the connected wireless type universal serial bus host.

5. The power managing method of a wireless type universal serial bus apparatus according to claim 1, wherein the performing the power control comprises:
releasing the connection from the wireless type universal serial bus host when all the wireless type universal serial bus host near the apparatus are powered off, and the wireless type universal serial bus apparatus is powered on;
switching a state of the wireless type universal serial bus apparatus to a dormant state; and
connecting the wireless type universal serial bus apparatus to the wireless type universal serial bus host near the apparatus.

6. The power managing method of a wireless type universal serial bus apparatus according to claim 1, wherein the performing the power control comprises:
performing a wireless communication with the wireless type universal serial bus host by connecting the wireless type universal serial bus apparatus to the wireless type universal serial bus host and releasing the connection when all of the wireless type universal serial bus host near the apparatus are powered off; and
checking whether the recharging is completed or not when the wireless type universal serial bus apparatus is powered off.

7. The power managing method of a wireless type universal serial bus apparatus according to claim 1, wherein, in the performing the power control, when the wireless type universal serial bus host and the wireless type universal serial bus apparatus are powered off, whether the recharging is completed or not is checked.

8. A wireless type universal serial bus apparatus associated with a wireless type universal serial bus host to carry out wireless universal serial data transmission and reception and a multimedia streaming service, the apparatus comprising:
a main body including a solar battery attached to an outer side thereof to supply an electric power and a rechargeable device to supply the electric power when the electric power is off;
a power controller to control a connection to and a release from the wireless type universal serial bus host, and a switching of a state of the wireless type universal serial bus apparatus to a dormant state to reduce a power consumption when the wireless type universal serial bus host is powered off; and
a universal serial bus port to be directly connected to the wireless type universal serial bus host.

9. The wireless type universal serial bus apparatus according to claim 8, further comprising a self-power port to supply the electric power when the electric power is not supplied from the solar battery and a bus power.

10. The wireless type universal serial bus apparatus according to claim 8, wherein the power controller connects the wireless type universal serial bus apparatus to the wireless type universal serial bus host, when the wireless type universal serial bus host and the wireless type universal serial bus apparatus are powered on.

11. The wireless type universal serial bus apparatus according to claim 8, wherein the power controller releases the connection from the wireless type universal serial bus host when the wireless type universal serial bus host is connected to the wireless type universal serial bus apparatus, the wireless type universal serial bus host is powered off, and the wireless type universal serial bus apparatus is powered on, and switches the state of the wireless type universal serial bus apparatus to the dormant state when there is no available wireless type universal serial bus host near the wireless type universal serial bus apparatus.

12. The wireless type universal serial bus apparatus according to claim 8, wherein the power controller releases the connection from the wireless type universal serial bus host and checks whether the recharging is completed, when the wireless type universal serial bus host and the wireless type universal serial bus apparatus are powered off.

13. The wireless type universal serial bus apparatus according to claim 8, wherein the power controller checks whether the recharging is completed when the wireless type universal serial bus host is powered on and the wireless type universal serial bus apparatus is powered off.

14. A wireless type universal serial bus apparatus associated with a wireless type universal serial bus host to carry out data transmission and reception and a multimedia streaming service, the apparatus comprising:
a power managing process to manage an electric power supplied from a solar battery, a self-power, and a bus power;
a wireless processing process to process a communication with the wireless type universal serial bus host using wireless media;
a connection managing process to manage the connection to and the release from the wireless type universal serial bus host, and to switch a state of the wireless type universal serial bus apparatus to a dormant state when all of the wireless type universal serial bus host near the wireless type universal serial bus apparatus are powered off; and
a data transfer process to transfer and receive data to and from the wireless type universal serial bus host and to carry out the multimedia streaming service.

15. The wireless type universal serial bus apparatus according to claim 14, further comprising:
a protocol processing process to encode and decode data to be transferred through the wireless media; and
an apparatus interface process to carry out interfacing with other types of universal serial bus apparatus.

16. The wireless type universal serial bus apparatus according to claim 14, wherein the connection managing process connects the wireless type universal serial bus apparatus to the wireless type universal serial bus host when the wireless type universal serial bus host and the wireless type universal serial bus apparatus are powered on.

17. The wireless type universal serial bus apparatus according to claim 14, wherein the connection managing process releases the connection from the wireless type universal serial bus host when the wireless type universal serial bus host is connected to the wireless type universal serial bus apparatus, the wireless type universal serial bus host is powered off, and the wireless type universal serial bus apparatus is powered on, and to switch the state of the wireless type universal serial bus apparatus to the dormant state when there is no available wireless type universal serial bus host near the wireless type universal serial bus apparatus.

18. The wireless type universal serial bus apparatus according to claim 14, wherein the power managing process releases the connection from the wireless type universal serial bus host when the wireless type universal serial bus host and the wireless type universal serial bus apparatus are powered off, and to check whether the recharging is completed.

19. The wireless type universal serial bus apparatus according to claim 14, wherein the power managing process checks whether the recharging is completed when the wireless type universal serial bus host is powered on and the wireless type universal serial bus apparatus is powered off.
